(19) United States
(12) Patent Application Publication
(10) Pub. No.: US 2003/0047347 A1
(43) Pub. Date: Mar. 13, 2003

(54) Single differential pair of flexible cables for differential mode systems

(76) Inventors: Gwun-Jin Lin, Toayuan (TW); Chi-Kuang Hwang, Toayuan (TW); Ching-Cheng Tien, Toayuan (TW)

Correspondence Address: SUPREME PATENT SERVICES, POST OFFICE BOX 2339, SARATOGA, CA, 95070, US

(21) Appl. No.: 09/948,185

(22) Filed: Sep. 7, 2001

(51) Int. Cl. H01B 11/02

(52) U.S. Cl. 174/113 R

(57) ABSTRACT

The present invention relates to a single differential pair of flexible cables capable of impedance and/or transmission time control, and it has advantages such as a short prototype development time without layout, suitability for a small opening structure, standard specifications, fill utilization of raw materials, less risk of overstock, etc. The pair of flexible cables also has advantages that a micro coaxial cable doesn't do, including: a real differential mode with a virtual ground; both ends of the flexible cable being preformed in certain type, such as in a bare copper type or a copper with base film type; capability of variation of cable length with the same impedance and transmission time; and capability of variation of transmission time with the same impedance and cable length.

### FIELD OF THE INVENTION

The present invention relates to single differential pair of flexible cables, and more specifically, to impedance and/or transmission time controlled flexible cables with only a pair of differential mode transmission lines. It is aimed for competing with a micro coaxial cable, which is capable of shortening the development time of prototype without layout and fitting with some structural constraints such as a passage of small round hole or square hole.

### BACKGROUND OF THE INVENTION

The flexible cables have been widely used in notebook computers for connecting the liquid crystal display (LCD) to the main system. A Low Voltage differential signals (LVDS) structure has been implemented for high transmission data rate for reducing power consumption and noise interference. However, a serious competition comes from the micro coaxial cables because of its short prototype producing time that some models of notebook computers have adopted the micro coaxial cables instead of the flexible cables. As the micro coaxial cables are not suitable for a bending mode, so the outfit of the main system for the cable to penetrate through has been changed from a hinge with pipe or shaft type flat rectangle to a small round hole or a small square hole. This change has modified the bending mode to a torsion mode to improve the suitability of the micro coaxial cables for the notebook computers. However, the micro coaxial cable with low temperature sustained ability would cost more as compared with a well-design flexible cable, which is capable of reducing EMI. Therefore, some engineers try to switch back from the micro coaxial cables to the flexible cables, which the small round or square hole is no longer applicable to.

This invention is aimed for solving this problem to establish the compatibility of the flexible cables for saving the cost of raw material and product stock.

### SUMMARY OF THE INVENTION

Structural constraints such as small holes are suitable for the micro coaxial cables, but it normally is not suitable for the flexible cables. This invention is to standardize a single differential pair of flexible cables with impedance and/or transmission time control, so we can easily assemble these cables and fit structure conditions as of a small hole as the micro coaxial cables do. Either end of this cable can be preformed in a bare copper type in which a plurality of signal transmission lines are extended outside the cable, so each cable has two ends for connecting to connectors or circuit boards. Furthermore, either end of this cable can also be preformed in copper with base film type in which each of signal transmission lines has only one side for contacting the connectors or circuit boards. These types are more convenient as compared with the micro coaxial cables in which both ends need to be stripped off instead of being preformed. Moreover, the pair of transmission lines in the differential mode is kept in the same layer to maintain a virtual ground for controlling impedance. This is quite difficult for the micro coaxial cables because its shielding surface surrounds each micro coaxial cable itself. That is, two micro coaxial cables are needed for the differential mode, but there is a real ground between them formed by their shielding surfaces to make the situation more complicated.

Another object of the invention is to design a single differential pair of cables with same transmission time and impedance however different cable lengths, which is sometimes required in some special layouts. Similarly, we can design the cables with same impedance and cable length however different transmission time, which is sometimes required under some special situations. The micro coaxial cable is inapplicable to both alternatively. The impedance and transmission time controlled by void patterns or solid patterns on shielding planes are extended from the U.S. Pat. No. 6,225,568 B1.

In order to control impedance and electromagnetic interference of the flexible cables, the shortest distance between the edges of the cable and the edges of transmission lines is preferably larger than three times of the thickness of the substrates. Other features and advantages of the present invention will become apparent from the following description referred to the accompanying drawings.

A connecting element or a circuit board with a set of ground transmission elements for a cable to connect is preferably arranged without extra wires to save cost and suit to structural constraints. They can be arranged to contact with shielding planes on a single differential pair of flexible cables or with extra ground transmission elements preformed in the single differential pair of flexible cables. In order to keep a real differential mode, extra ground transmission elements cannot be arranged between the single differential pair of positive and negative signal transmission elements. The main ground transmission element is preferably connected with a wire.

A flexible cable is combined with a first set of common mode signal, power, or ground transmission elements and a second set of differential mode signal transmission elements, in which the latter is separated in pairs. Each of the first set of common mode signal, power, or ground transmission elements is separated from each other. Each of the first set of common mode signal, power, or ground transmission elements is preferably implemented with other types of cable, such as the regular wires for low frequency or the micro coaxial cables for high frequency. This separation method can also reduce the EMI interference.

### BRIEF DESCRIPTION OF THE DRAWINGS

FIG. 1 depicts a plan view of a single differential pair of flexible cables.

FIG. 2 depicts a cross-sectional view of a single differential pair of flexible cables taken along line 2-2 in FIG. 1.

FIG. 3 depicts a plan view of a single differential pair of flexible cables with one shielding plane.

FIG. 4 depicts a cross-sectional view of a single differential pair of flexible cables with one shielding plane taken along line 4-4 in FIG. 3.

FIG. 5 depicts a plan view of a single differential pair of flexible cables with two shielding planes.

FIG. 6 depicts a cross-sectional elevational view of a single differential pair of flexible cables with two shielding planes taken along line 6-6 in FIG. 5.

FIG. 7 depicts a plan view of a single differential pair of flexible cables with a surrounding shielding plane.

FIG. 8 depicts a cross-sectional elevational view of a single differential pair of flexible cables with the surrounding shielding plane taken along line 8-8 in FIG. 7.

FIG. 9 depicts a front view of a single differential pair of flexible cable with two shielding planes, in which both ends of the single differential pair are preformed in a bare copper type and a copper with base film type.

FIG. 10 depicts a plan view of the flexible cable in which each pair of differential mode signal transmission elements is implemented with this invention, and common mode signal transmission elements can be implemented with other cable such as the regular wires for low frequency or the micro coaxial cables for high frequency.

### DETAILED DESCRIPTION OF THE INVENTION

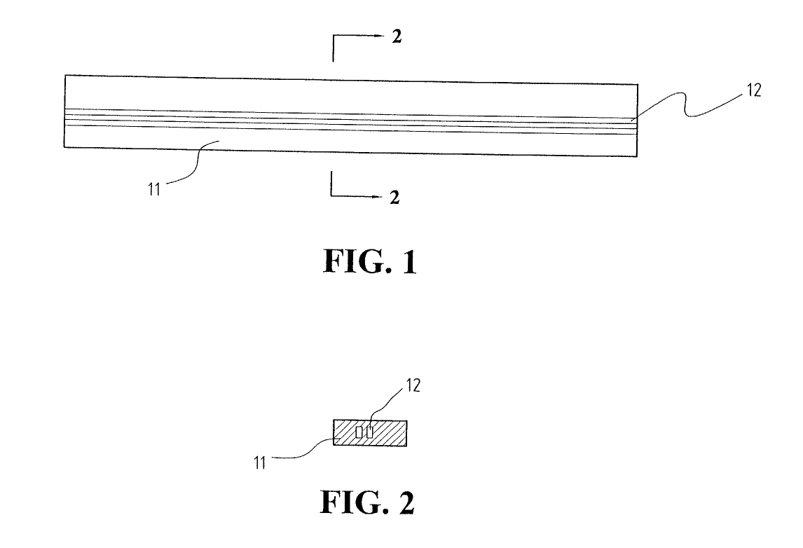

A single differential pair of flexible cables capable of impedance control or transmission time control by using geometry of a pair of signal transmission elements (12) and depending on the thickness as well as the dielectric constant of an insulated substrate (11) is presented in FIG. 1. FIG. 2 shows a cross-sectional view of the single differential pair of flexible cables taken along line 2-2 in FIG. 1.

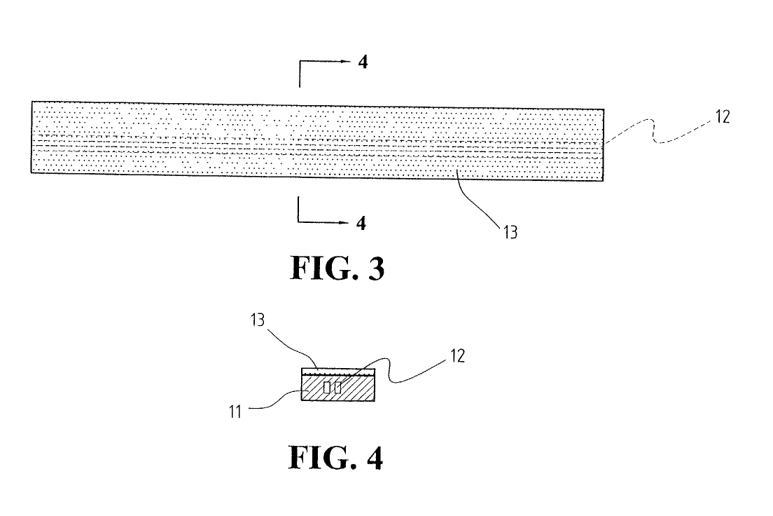

The single differential pair of flexible cables with one shielding plane, which controls impedance or transmission time by using the combination of void patterns or solid patterns on the shielding plane (13), geometry of the pair of signal transmission elements (12), and depending on the thickness as well as the dielectric constant of the insulated substrate (11), is presented in FIG. 3. FIG. 4 shows a cross-sectional view of the single differential pair of flexible cables taken along line 4-4 in FIG. 3.

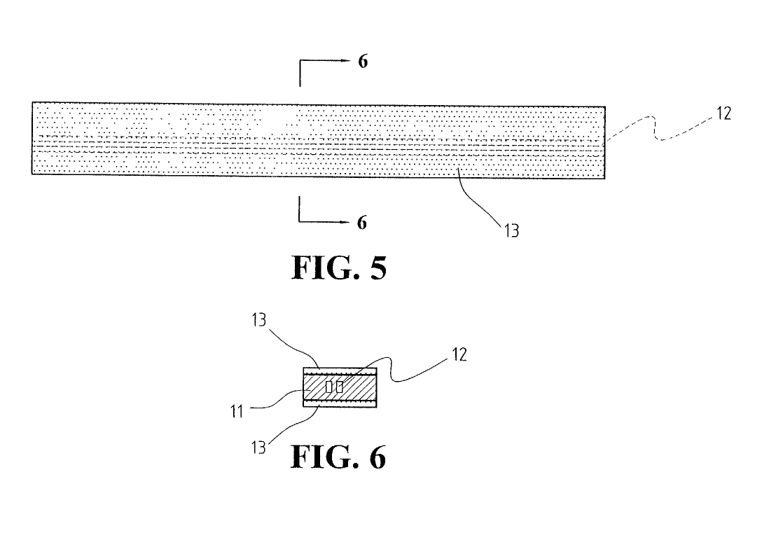

A single differential pair of flexible cables with two shielding planes, which controls impedance or transmission time by using the combination of void patterns or solid patterns on these two shielding planes (13), geometry of the pair of signal transmission elements (12), and depending on the thickness as well as the dielectric constant of the insulated substrate (11) is presented in FIG. 5. FIG. 6 shows a cross-sectional view of the single differential pair of flexible cables taken along line 6-6 in FIG. 5.

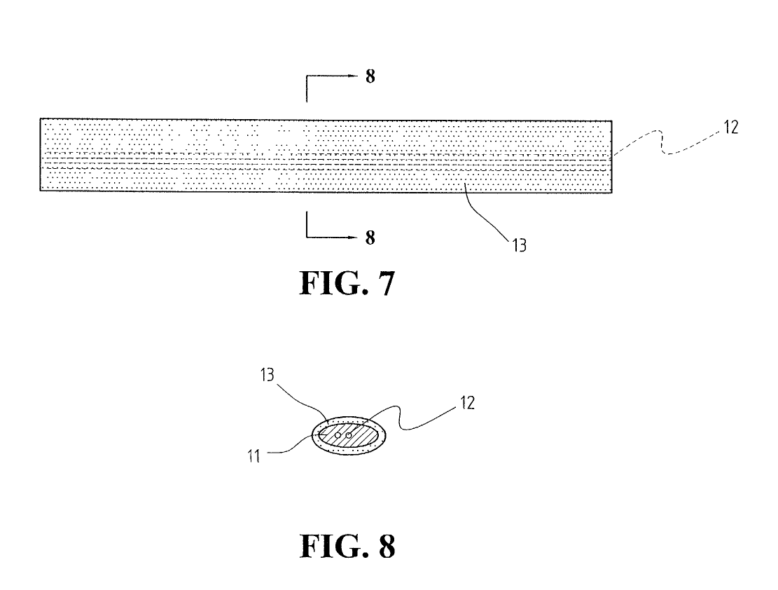

Void patterns or solid patterns on these shielding planes are omitted for simplifying the drawings. A virtual ground is defined as the center of the pair of signal transmission elements (12) in differential mode. The distance between the edges of the single differential pair of flexible cables and the virtual ground should be larger than the spacing between the pair of signal transmission elements (12) in differential mode. FIG. 7 depicts a plan view of a single differential pair of flexible cables with a surrounding shielding plane. FIG. 8 depicts a cross-sectional view of the single differential pair of flexible cables with the surrounding shielding plane taken along line 8-8 in FIG. 7.

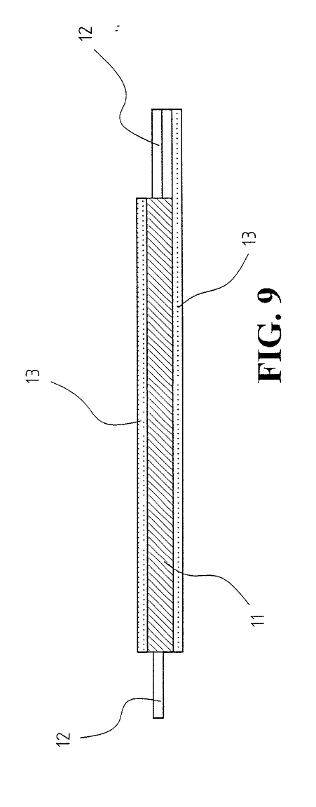

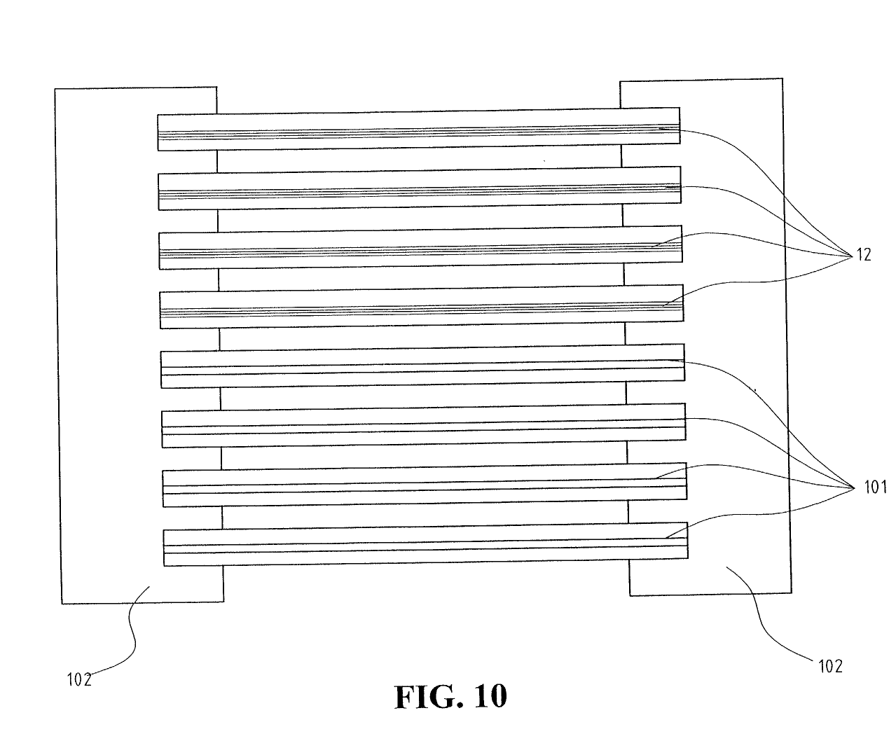

A bare copper at the left end while a copper with base film at the right end of the single differential pair of flexible cables are shown in FIG. 9. A plan view of a flexible cable in a common mode (101) or the differential mode (12) of signal transmission elements is connected with two connection elements (102) as shown in FIG. 10, in which the differential mode signal transmission elements (12) are separated in pairs to be implemented with this invention and the common mode signal transmission elements (101) can be implemented with other cables, such as the regular wires for low frequency or the micro coaxial cables for high frequency.

Although only the preferred embodiments of this invention have been shown and described in the above description, it is apparent that numerous variations and modifications may be made without departing from the true spirit and scope thereof, as set forth in the claims below.

What is claimed is:

1. A single differential pair of flexible cables combined with a first set of common mode signal, power, or ground transmission elements and a second set of differential mode signal transmission elements, wherein said second set of differential mode signal transmission elements is separated in pairs.

2. The pair of flexible cables as claimed in claim 1, wherein each pair of said set of differential mode signal transmission elements is individually implemented as a single differential pair.

3. The pair of flexible cables as claimed in claim 1, wherein each of said set of common mode signal. power, or ground transmission elements is separated from each other and each of said first set of common mode signal, power, or ground transmission elements is preferably implemented with another type of cables, such as the regular wires for low frequency or the micro coaxial cables for high frequency.

4. The pair of flexible cables as claimed in claim 1, wherein all said pairs of differential mode signal transmission elements and each said set of common mode signal, power, or ground transmission elements are separated and arranged together to fit structural constraints.

5. A single differential pair of flexible cables, comprising a connecting element or a circuit board having a set of ground transmission elements, wherein some of the ground transmission elements, preferably without connecting extra wires, are connected with shielding planes on the flexible cables or with extra ground transmission elements preformed in the flexible cables, in which said extra ground transmission elements can not be arranged between said single differential pair of positive and negative signal transmission elements.

6. A single differential pair of flexible cables, comprising at least: a substrate and a single pair of signal transmission elements in differential mode capable of impedance control, transmission time control, or electromagnetic radiation control.

7. The pair of flexible cables as claimed in claim 6, further comprising: at least a shield plane for the differential mode capable of impedance control, transmission time control, or electromagnetic radiation control.

8. The pair of flexible cables as claimed in claim 6, wherein at least one end of said single pair of signal transmission elements in differential mode is preformed in a bare copper type or a copper with base film type.

9. The pair of flexible cables as claimed in claim 7, wherein at least one end of said single pair of signal transmission elements for the differential mode is preformed in a bare copper type or a copper with base film type.

10. The pair of flexible cables as claimed in claim 6, wherein the single pair of signal transmission elements is designed in same impedance, same transmission time, but different cable lengths.

11. The pair of flexible cables as claimed in claim 6, wherein the single pair of signal transmission elements is provided with same cable length, same impedance, but different transmission time.

12. The pair of flexible cables as claimed in claim 7, wherein the single pair of signal transmission elements is designed in same impedance, same transmission time, but different cable lengths.

13. The pair of flexible cables as claimed in claim 7, wherein the single pair of signal transmission elements is provided with same cable length, same impedance, but different transmission time.

14. The pair of flexible cables as claimed in claim 6, wherein a shortest distance between edges of said signal transmission elements and the edge of said flexible cable is preferably three times larger than the thickness of said substrate.

15. The pair of flexible cables as claimed in claim 7, wherein a shortest distance between edges of said signal transmission elements and the edge of said flexible cable is preferably three times larger than the thickness of said substrate.

16. The pair of flexible cables as claimed in claim 7, wherein said impedance and said transmission time are controlled by the void patterns or the solid patterns on said shielding plane.
